(19) United States
(12) Patent Application Publication
(10) Pub. No.: US 2006/0050315 A1
(43) Pub. Date: Mar. 9, 2006

(54) Method and apparatus for inputting and outputting image data, computer program for executing the method, and recording medium for the computer program

(76) Inventors: Yuriko Obata, Tokyo (JP); Hiromitsu Shimizu, Yokohama-shi (JP); Norio Michiie, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/221,703

(22) Filed: Sep. 9, 2005

(30) Foreign Application Priority Data
Sep. 9, 2004 (JP) 2004-262441

(51) Int. Cl. G06K 15/00

(52) U.S. Cl. 358/1.16

(57) ABSTRACT

An image input and output apparatus includes an image input unit, a memory, an image output unit, a first internal memory unit to internally store the image data input from an outside of the image output unit, a first deletion unit to delete the image data from the first internal memory unit before reading out the image data, a second deletion unit to delete the image data from the first internal memory unit after reading out the image data, an identification unit to identify a characteristic of the image data, and a selection unit to select the first or second deletion unit to delete the image data stored in the first internal memory unit according to the characteristic of the image data input from the outside of the image input unit.

### CROSS REFERENCE TO RELATED APPLICATIONS

The present application claims priority to Japanese patent application no. 2004-262441, filed in the Japan Patent office on Sep. 9, 2004, the disclosure of which is incorporated by reference herein in its entirety.

### BACKGROUND OF THE INVENTION

1. Field of the Invention

The present invention relates to a method and apparatus for inputting and outputting image data, a computer program for executing the method, and a recording medium for the computer program. More particularly, the present invention relates to an image input and output apparatus having an image processing function for executing image processing on input image data. The present invention further relates to a method executed by the image input and output apparatus, a computer program for executing the image input and output method, and a recording medium on which the computer program executed by the computer is stored in an executable manner.

2 . Discussion of the Background

In an image forming apparatus including an image input and output apparatus, image data is converted and processed based on a user's request. In the image forming apparatus connected with a facsimile machine or a network, besides a scanner and a printer, a variety of data conversion techniques are used depending on the type of output image data. Further, high speed processing of a requested image input or output is indispensable.

To execute image data conversion with high speed, when inputting or outputting image data, the image input and output apparatus often include a buffer memory. The buffer memory executes image data conversion with respect to a respective image input device and image output device. In a background technique, although a period for storing image data is short, the image data is stored in the buffer memory.

When a capacity of the buffer memory is not large enough, it may be impossible to identify a content of the image data even with help of a content of the stored data. However, the buffer memory having the capacity approximately equivalent to an amount of one page may be required, depending on the type of data conversion technique used. As a result, when the image data is stored for even a short period, it is possible that the image data is leaked. This may happen by intentionally reading the image data, even if the image forming apparatus does not have a function of reading out the image data stored in the buffer memory. In recent years, a variety of standards associated with information security have been gradually enacted, while a variety of countermeasures have been discussed to prevent the stored image data from being leaked when storing the image data in the buffer memory.

For example, there are several countermeasures as follows. Data encryption or file access restriction is incorporated to protect the stored image data from being leaked when further connecting the memory with another memory such as a hard disk. There is provided a function of deleting not only file allocation data but also an image data area itself, upon deletion of the data. A mechanism in which the memory is detachably installed with ease by the user is also employed.

According to reasons described above, for example, a technique has been proposed where a disk storage device, provided with an efficient and effective security function, has a function of deleting data so the data is not leaked.

One way to protect the image data as described above is to use an image forming apparatus including a memory capable of running an application software to control input and output of the image data.

Another way is to provide a third party with an environment for developing the application software so that the image forming apparatus may be controlled. Hence, there is a great demand for higher security so as to prevent leaking of the image data during a period when image input and output units process the input and output of the image data. Thus, it may be effective that the processing performed by the application software is limited to processing of the image data in the buffer memory for the data conversion or data processing, and a device is provided for preventing the image data stored in the buffer memory from being leaked. As a result, this may provide an apparatus which can achieve higher security for prevent leaking and easily develop application software.

When the buffer memory for the image data conversion employs a device for encrypting the image data, the processing period may be long, which may decrease the productivity of an image forming apparatus. Therefore, it is difficult to employ the device as described above.

Therefore, as discovered by the present inventor, it is desirable to provide a method and apparatus for inputting and outputting image data capable of identifying a characteristic of a document image so that, when the characteristic identified by the above-described apparatus matches a predetermined characteristic, the image data can automatically be deleted from a memory in the image forming apparatus.

### SUMMARY OF THE INVENTION

The present invention has been made in view of the above-described and other circumstances and addresses the above-discussed and other disadvantages.

In one embodiment, a novel image input and output apparatus includes an image input unit, a memory, an image output unit, a first internal memory unit, first and second deletion units, an identification unit, and a selection unit. The image input unit is configured to input an image data signal of image data. The memory is configured to store the image data signal of the image data input from the image input unit. The image output unit is configured to output the image data signal of the image data stored in the memory. The first internal memory unit is included in the image output unit and is configured to internally store the image data input from outside of the image data output unit. The first deletion unit is configured to delete the image data from the first internal memory unit before reading out the image data therefrom. The second deletion unit is configured to delete the image data from the first internal memory unit after reading out the image data therefrom. The identification unit is configured to identify a characteristic of the image data input from outside of the image input unit. The selection unit is configured to select one of the first and second deletion units to delete the image data stored in the first internal memory unit according to the characteristic of the image data input from the outside of the image input unit.

The novel image input and output apparatus may further include an operation unit configured to perform the selection performed by the selection unit from outside of the image output unit.

Further, in one embodiment, a novel method of inputting and outputting image data includes identifying a characteristic of an image data signal of the image data input to an image forming apparatus, storing input image data including the characteristic of the image data signal of the image data input to the image forming apparatus, to an internal memory unit, selecting one of first and second procedures according to the characteristic of the image data signal of the image data identified in the identifying, the first procedure including deleting the input image data stored in the storing, and reading out the input image data, and the second procedure including reading out the input image data stored in the storing, and deleting the input image data from the internal memory unit.

In another embodiment, a computer program product stored on a computer readable storage medium run on an image input and output apparatus carries out an image processing method, as described above.

Further, in another embodiment, a computer readable medium storing computer instructions performs an image inputting and outputting method, as described above.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic diagram of a digital copier according to an exemplary embodiment of the present invention;

FIG. 2 is a diagram illustrating a document setting table of FIG. 1 viewed from above;

FIG. 3 is a timing chart illustrating an output timing of an image synchronization signal output from an image processing unit (IPU) in a reading part;

FIG. 4 is a block diagram illustrating a configuration of a memory part;

FIG. 5 is a block diagram illustrating an exemplary embodiment of an image forming apparatus (or a composite machine) including functions of respective devices such as a printer, a copier, a facsimile machine, and a scanner in a single housing;

FIG. 6 is a diagram illustrating a hardware configuration of the composite machine according to exemplary embodiments of the present invention;

FIG. 7 is a diagram illustrating a relation among a local memory, an application specific integrated circuit (ASIC), and an engine of FIG. 6 according to an exemplary embodiment of the invention;

FIG. 8 is a flowchart illustrating a processing procedure for changing an order of deleting and reading out the image data stored in a memory unit, according to a characteristic of the image data;

FIG. 9 is a flow chart illustrating a processing procedure for changing an order of deleting and reading out the image data stored in the memory unit, according to an input signal from an external device;

FIG. 10 is a flowchart illustrating a processing procedure for deleting the image data regardless of switching instructions from an external device when the characteristic of image data is identified; and

FIG. 11 is a flowchart illustrating a processing procedure for forcibly deleting the image data stored in the memory unit when a predetermined characteristic of image data is identified.

### DETAILED DESCRIPTION OF THE PREFERRED EMBODIMENTS

In describing preferred embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner.

Referring now to the drawings, wherein like reference numerals designate identical or corresponding parts throughout the several views, preferred embodiments of the present invention are described.

It is important to note that, in the exemplary embodiments hereinafter described, an image input unit corresponds to a reading part 100 or a scanner 120-5, i.e., an input. A memory corresponds to a memory part 205 or a local memory (MEM-C) 67. An image output unit corresponds to an image forming part 300 or a plotter 120-0, i.e., an output. A first internal memory unit corresponds to a dynamic random access memory 120-1 (DRAM 120-1) and a second internal memory unit corresponds to a dynamic random access memory (DRAM) (not shown) stored in a scanner control part 105. First and second deletion units, an identification unit, and a selection unit correspond to a central processing unit 61 (CPU 61) in a system control part 201. An operation unit corresponds to an operation part 202 or an operation panel 70. A first step corresponds to steps S101, S203, or S301, a second step corresponds to steps S102, S204, or S302, a third step corresponds to steps S103, S103′, S205 and S206, or S304 and S305, a fourth step corresponds to steps S104 and S105, S207 and S208, or S306 and S307, and a fifth step corresponds to steps S106 and S107, S209 and S210, or S308 and S309.

In addition, in the respective units described above and exemplary embodiment which will be described below, a term “image signal” represents an image signal in itself which is input or read, and a term “image data” represents aggregation of the image signals and the aggregation thereof functions as a piece of information.

Hereinafter, exemplary embodiments of the present invention will be described with reference to the drawings.

In an exemplary embodiment, as an example, an image data output device is a digital copier.

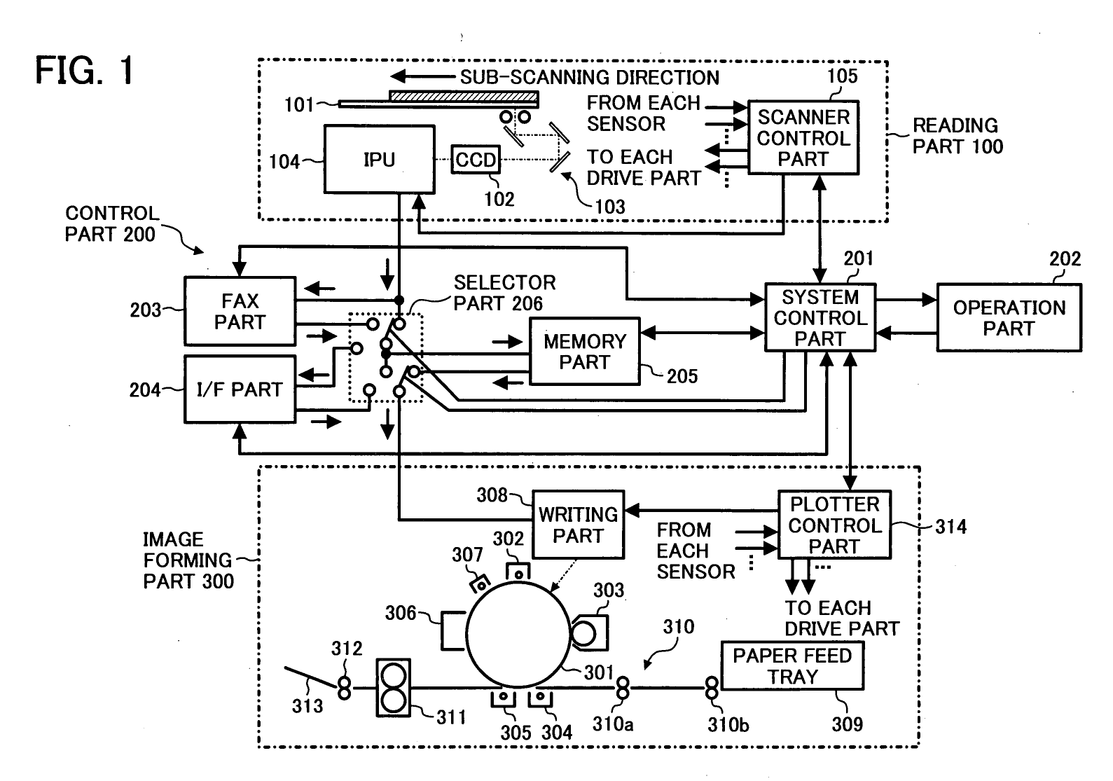

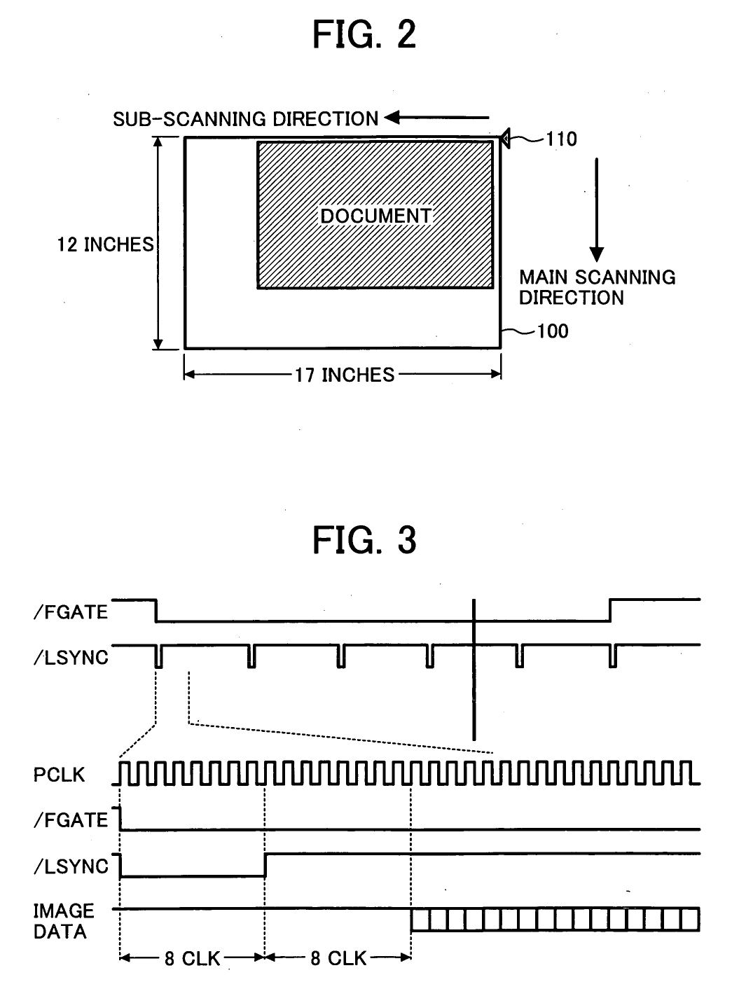

Referring to FIGS. 1 and 2, a structure of a digital copier is, shown as one example of an image data output device according to an exemplary embodiment of the present invention.

In FIG. 1, basically, the digital copier includes a reading part 100, a control part 200, and an image forming part 300.

The reading part 100 includes a document setting table 101, a charged-coupled device (CCD) sensor 102, an optical reading system 103, an image processing unit 104, and a scanner control part 105.

The document setting table 101 is made up of a contact glass. The optical reading system 103 is provided at an under surface of the document setting table 101. The optical reading system 103 includes a functioning of irradiating illumination light onto a document and guides the light reflected from the document to the CCD sensor 102 (or an image sensor) by using, e.g., a first mirror through a third mirror. The image processing unit 104 (or IPU 104) converts data optically read by the CCD sensor 102, into digital data capable of being used in a subsequent stage. The scanner control part 105 controls each part described above.

In a reading procedure for the reading part 100 of the thus configured digital copier, scan exposure is performed by using an exposure lamp in the optical reading system 103 capable of moving the document in a sub-scanning direction along the document setting table 101, and photoelectric conversion of the reflected light from the document is performed by using the CCD sensor 102 to produce electrical signals in response to a level of the reflected light. The IPU 104 processes the electrical signals to perform shading correction or the like to execute analog-to-digital conversion (or A/D conversion), so that the electrical signals may be converted into 8-bit digital signals. After image processing such as variable power processing and dither processing is performed, an image signal is sent to the image forming part 300 together with an image synchronization signal.

The scanner control part 105 detects respective sensors, controls a drive motor or the like, and sets a variety of parameters for the IPU 104 so that the scanner control part 105 may perform the processes described above.

The above-described processes performed in the reading part 100 may be included in a reading process of the reading part 100 of the digital copier of FIG. 1.

FIG. 2 shows the document setting table 101 of the reading part 100, viewed from the top of the digital copier of FIG. 1. A document to be scanned is set on the document setting table 101 of FIG. 2. Here, an arrow portion 110 in FIG. 2 indicates a beginning of the image data to be scanned. A horizontal arrow facing left indicates a sub-scanning direction, and a vertical arrow facing below indicates a main-scanning direction by the scan-exposure. A dimension of the document setting table 101 in FIG. 2 is, e.g., approximately 12 inches in height and approximately 17 inches in width.

The control part 200 includes a system control part 201, an operation part 202, a facsimile part 203, an interface (I/F) part 204, a memory part 205, and selector part 206.

The system control part 201 controls the entire digital copier. The operation part 202 functions as a user interface for the system control part 201. The facsimile part 203 executes a facsimile transmission to and from an external facsimile machine. The interface part 204 controls an input and output from and to external devices. The memory part 205 stores received information, information to be sent, and image data to be transmitted to the image forming part 300. The selector part 206 switches signal transmission and signal reception between the reading part 100, the facsimile part 203, the interface part 204 (I/F), or the image forming part 300 and the memory part 205.

The system control part 201 detects an input state set on the operation part 202 by an operator to perform setting of the variety of parameters and process execution instructions for the reading part 100, the memory part 205, the image forming part 300, and the facsimile part 203 through communications. The operation part 202 accepts inputs from the operator. In addition, the operation part 202 displays a state of an entire system on a display. The instructions for the system control part 201 are performed by the operator through the inputs to the operation part 202 by an operator's key entry.

The facsimile part 203 performs, based on an instruction from the system control part 201, binary compression of the transmitted image data based on a data transfer protocol such as G3/G4 Fax to transfer to a telephone line. In addition, data transferred from the telephone line to the facsimile part 203 is decompressed to produce binary image data, and the binary image data is further sent to a writing part 308 of the image forming part 300. At the writing part 308, the received image data is modulated, so that the image data is written in an optical manner on a surface of a photoconductive drum 301 to be visualized through the image forming process.

As described above, the interface (I/F) part 204 serves as an interface used for controlling inputs and outputs transmitted from and to external devices such as personal computers as a terminal.

The memory part 205 is generally used for applications required for copying such as repeat copying, rotation copying, or the like by storing the image data of the document-input from the IPU 104. The memory part 205 is also used as a buffer memory in which the binary image data from the facsimile part 203 is temporarily stored. These instructions for storing the data is given by the system control part 201.

The selector part 206 changes a state of a selector based on an instruction from the system control part 201 to select an image data source for performing image formation from any of the reading part 100, the memory part 205, and the facsimile part 203.

The image forming part 300 includes the photoconductive drum 301, a charging charger 302, a developing device 303, a transfer charger 304, a separation charger 305, a cleaning device 306, a discharging charger 307, the writing part 308, a sheet feeding tray 309, a sheet feeding device 310, a fixing device 311, a pair of sheet discharging rollers 312, and a sheet discharging tray 313.

On the surface of the photoconductive drum 301, a photoconductive layer is formed. Along an outer circumference of the photoconductive drum 301, the charging charger 302, the developing device 303, the transfer charger 304, the separation charger 305, the cleaning device 306, and the discharging charger 307 are arranged. The writing part 308 performs optical writing on the photoconductive drum 301 to form an electrostatic latent image on the surface of the photoconductive drum 301. The sheet feeding device 310 includes the sheet feeding tray 309, a pair of registration rollers 310a, a pair of sheet feeding rollers 310b, and a conveyance roller (not shown). The sheet feeding tray 309 feeds a sheet-shaped transfer material as a transfer medium (hereinafter, referred to as a “paper”) between the photoconductive drum 301 and the transfer charger 304, and between the photoconductive drum 301 and the separation charger 305. The fixing device 311 fixes a toner image transferred onto the sheet. The pair of sheet discharging rollers 312 discharges the sheet on which the image is fixed to the sheet discharging tray 313 so that the paper can be loaded thereon.

Each part of the image forming part 300 is controlled by a plotter control part 314.

In an image forming process executed by the image forming part 300, the charging charger 302 uniformly charges the surface of the photoconductive drum 301 which rotates at a constant speed. The writing part 308 emits a laser light beam modulated according to the image data and irradiates the photoconductive drum 301 to form an electrostatic latent image on the photoconductive layer of the surface of the photoconductive drum 301. The developing device 303 develops the electrostatic latent images formed on the photoconductive drum 301 with toner to produce a visualized toner image. A sheet of paper fed and conveyed from the sheet feeding tray 309 of the sheet feeding device 310 is conveyed via the pair of sheet feeding rollers 310b to the pair of registration rollers 310a. In synchronization with the photoconductive drum 301, the paper is further conveyed so that the visualized toner image formed on the photoconductive drum 301 may be electrostatically transferred onto the paper by using the transfer charger 304. The separation charger 305 then separates the paper from the photoconductive drum 301. After the fixing device 311 fixes the toner image on the paper with application of heat and pressure, the paper is discharged onto the sheet discharging tray 313 via the pair of sheet discharging rollers 312.

After the toner image formed on the surface of the photoconductive drum 301 is transferred onto the paper conveyed from the sheet feeding device 310, the cleaning device 306 may remove a residual toner image remaining on the surface of the photoconductive drum 301 by being pressed against the photoconductive drum 301. The discharging charger 307 then electrostatically discharges the surface of the photoconductive drum 301.

The plotter control part 314 detects outputs from a variety of sensors and controls drive motors or the like to perform the processes as described above.

The above-described processes performed in the image forming part 300 may be included in an image forming process of the image forming part 300 of the digital copier of FIG. 1.

Referring now to FIG. 3, output timings for image synchronizations signals output by the IPU 104 of the reading part 100 are described.

In FIG. 3, a frame gate signal (/FGATE signal) is a signal representing an image effective range with respect to an image area in the sub-scanning direction, and the image becomes effective while the /FGATE signal is at a low level, i.e., low active. The /FGATE signal is asserted or negated at a falling edge of a line synchronization signal (/LSYNC signal). The /LSYNC signal is asserted by a predetermined number of clocks at a rising edge of a pixel synchronization signal (PCLK signal), and after the rising edge of the PCLK signal, the image data in a main scanning direction becomes effective after a predetermined number of clocks. As for the image data that is transmitted, one image data corresponds to one cycle of the PCLK signal, and the image data is substantially divided, on a 400 dpi basis, from a position indicated by the arrow portion 110, as shown in FIG. 2. The image data is sent as the data with a raster format, starting from the image data pointed by the arrow portion 110. An effective range in the sub-scanning direction of the image data is generally determined depending on the size of the sheet of paper to be transferred. It should be noted that the predetermined number of clocks described here, for example, is 8 CLK as shown in FIG. 3.

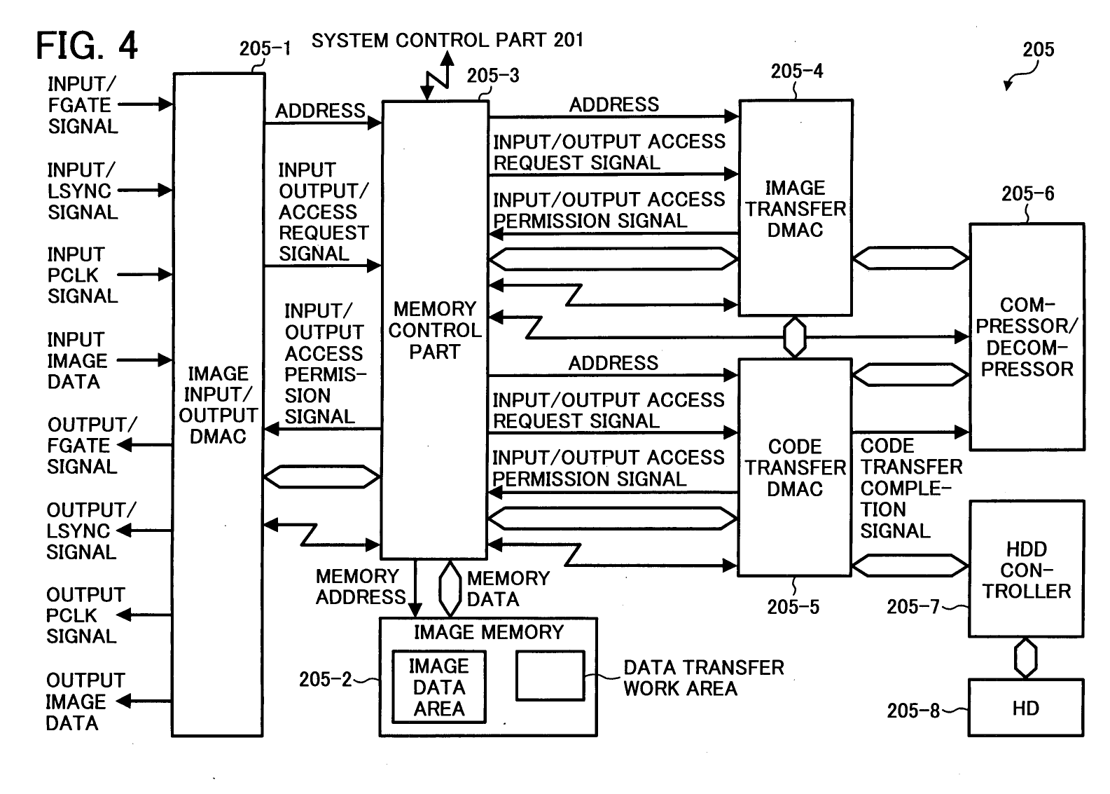

Referring now to FIG. 4, a schematic diagram of the memory part 205 is described.

In FIG. 4, the memory part 205 includes an image input and output direct memory access controller 205-1 (or an image input and output DMAC 205-1), an image memory 205-2, a memory control part 205-3, an image transfer direct memory access controller 205-4 (or an image transfer DMAC 205-4), a code transfer direct memory access controller 205-5 (or a code transfer DMAC 2055), a compressor-decompressor 205-6, a hard disk drive controller 205-7 (or a HDD controller 205-7), and a hard disk device 205-8 (or a HD 205-8).

Hereinafter, a detailed description will be given with respect to each block.

(1) Image Input and Output DMAC 205-1

The image input and output DMAC 205-1 includes a central processing unit (CPU) and logic circuits. The image input and output DMAC 205-1 communicates with the memory control part 205-3 and receives commands based on a transmission to and from the memory control part 205-3 so that operation settings in response to the commands can be set and the status information thereof may be sent to the memory control part 205-3 to inform of a state of the image input and output DMAC 2051.

Upon receiving the command for inputting image data, the image input and output DMAC 205-1 packs the input image data as memory data in units of eight pixels (8 pixels) based on an input pixel synchronization signal to output together with a memory access signal-such as an input and output access request signal to the memory control part 205-3, as needed. The image input and output DMAC 205-1 sends an address to the memory control part 205-3 and receives the input and output access permission signal from the memory control part 205-3.

Upon receiving the command for outputting image data, the image input and output DMAC 205-1 outputs the image data from the memory control part 205-3 while synchronizing the image data, as an output image data, with an output pixel synchronization signal.

In addition, an input /FGATE signal and an input /LSYN signal are input to the image input and output DMAC 205-1, and an output /FGATE signal and an output /LSYN signal are output from the image input and output DMAC 205-1.

(2) Image Memory 205-2

The image memory 205-2 is a primary storage for the image data. The image memory 205-2 is made up of a semiconductor memory element such as a dynamic random access memory (DRAM), or the like. The image memory 205-2, for example, has a total amount of memory capacity with 400 dpi (dot per inch) and holds a total amount of 9 MB (mega byte) memory including a 4 MB memory for a binary image data of A3 size, a 4 MB memory for storing electronic sort, and a 1 MB memory for storing data after data conversion. Readout and writing is controlled by the memory control part 205-3. The image memory includes an image data area and a data transfer work area and receives memory data and a memory address from the memory control part 205-3. The tasks described above are performed in both of the image data area and the data transfer work area.

(3) Memory Control Part 205-3

The memory control part 205-3 is made up of a central processing unit (CPU) and logic circuits. The memory control part 205-3 communicates with the system control part 201 and receives commands based on a transmission to and from the system control part 201 so that operation settings in response to the commands can be set and the status information thereof may be sent to the system control part 201 to inform the system control part of a state of the memory part 205. Operation commands from the system control part 201 include commands for image input, image output, compression, decompression, or the like. The commands for the image input and the image output are sent to the image input and output DMAC 205-1 while the commands associated with the compression and decompression are sent to the image transfer MDAC 205-4, the code transfer DMAC 205-5, and the compressor-decompressor 205-6. The memory control part 205-3 sends the addresses, and the input and output access request signals to the image transfer DMAC 205-4 and the code transfer DMAC 205-5, and receives the input and output access permission signals from the image transfer DMAC 205-4, and the code transfer DMAC 205-5.

Based on image input instructions from the system control part 201, the memory control part 205-3 is initialized to enter a wait state for the image data. When a scanner, that is, the reading part 100 starts its operation, the image data is input to the memory part 205. The input image data is temporarily written into the image memory 205-2.

In addition, a number of processed lines of the written image data is calculated at the image input and output DMAC 205-1 and is input to the memory control part 205-3. Although the compressor-decompressor 205-6 outputs a transfer memory access request signal upon receiving a command for transferring the image data, an actual memory access is not performed because a request mask part (not shown) of the memory control part 205-3 masks the request signal. When a single line of input data sent from the image input and output part is completed, the transfer memory access request signal may be unmasked, so that data from the image memory 205-2 can be read out to start a transfer operation of the image data to the compressor-decompressor 205-6. A difference between the numbers of two processed lines at a difference calculation part is calculated during the operation. When the result of the calculation is zero, the transfer memory access request signal is masked so as not to overtake an address.

(4) Image Transfer DMAC 205-4

The image transfer DMAC 205-4 is made up of a central processing unit (CPU) and logic circuits. The image transfer DMAC 205-4 communicates with the memory control part 205-3 and receives commands based on a transmission to and from the memory control part 205-3 so that operation settings in response to the commands can be set and the status information thereof may be sent to the memory control part 205-3 to inform of a state of the image transfer DMAC 205-4.

Upon receiving the command for compression, the image transfer DMAC 205-4 outputs the memory access request signal to the memory control part 205-3. When a memory access permission signal is activated, the image transfer DMAC 205-4 receives the image data to transfer the image data to the compressor-decompressor 205-6.

The image transfer DMAC 205-4 is provided with an address counter (not shown) therein for counting in response to a memory access request signal to output a 22-bit memory address indicating a storage location on which the image data is stored.

(5) Code Transfer DMAC 205-5

The code transfer DMAC 205-5 is made up of a central processing unit (CPU) and logic circuits. The code transfer DMAC 205-5 communicates with the memory control part 2053 and receives commands based on a transmission to and from the memory control part 205-3 so that operation settings in response to the commands can be set and the status information thereof may be sent to the memory control part 205-3 to inform of a state of the code transfer DMAC 205-5.

Upon receiving the command for decompression, the code transfer DMAC 205-5 outputs the memory access request signal to the memory control part 205-3. When the memory access permission signal is activated, the code transfer DMAC 205-5 receives the image data to transfer the image data to the compressor-decompressor 205-6.

In addition, the code transfer DMAC 205-5 is provided with an address counter (not shown) therein for counting in response to the memory access request signal to output the 22-bit memory address indicating the storage location on which the image data is stored.

When completing the transfer, the code transfer DMAC 205-5 sends a code transfer completion signal to the compressor-decompressor 205-6. A descriptor access operation of the DMCA will be described below.

(6) Compressor-Decompressor 205-6

The compressor-decompressor 205-6 is made up of a central processing unit (CPU) and logic circuits. The compressor-decompressor 205-6 communicates with the memory control part 205-3 and receives commands based on a transmission to and from the memory control part 205-3 so that operation settings in response to the commands can be set and the status information thereof may be sent to the memory control part 205-3 to inform of a state of the compressor-decompressor 205-6. The compressor-decompressor 205-6 processes binary data by, e.g., using a Modified Huffman (MH) encoding technique.

(7) HDD Controller 205-7

The HDD controller 205-7 is made up of a central processing unit (CPU) and logic circuits. The HDD controller 205-7 communicates with the memory control part 205-3 and receives commands based on a transmission to and from the memory control part 205-3 so that operation settings in response to the commands can be set and the status information thereof may be sent to the memory control part 205-3 to inform of a state of the HDD controller 205-7. The HDD controller 205-7 executes status reading and data transfer of the HD 205-8.

(8) HD 205-8

The HD 205-8 is a secondary storage and is a hard disk.

As for an entire operation of the memory part 205, when the system control part 201 may give instructions for inputting the image and storing the data, the image transfer DMAC 205-4 writes or reads out the image data to or from a predetermined image area of the image memory 205-2. The image transfer DMAC 205-4 counts a number of image lines during the above-described operation.

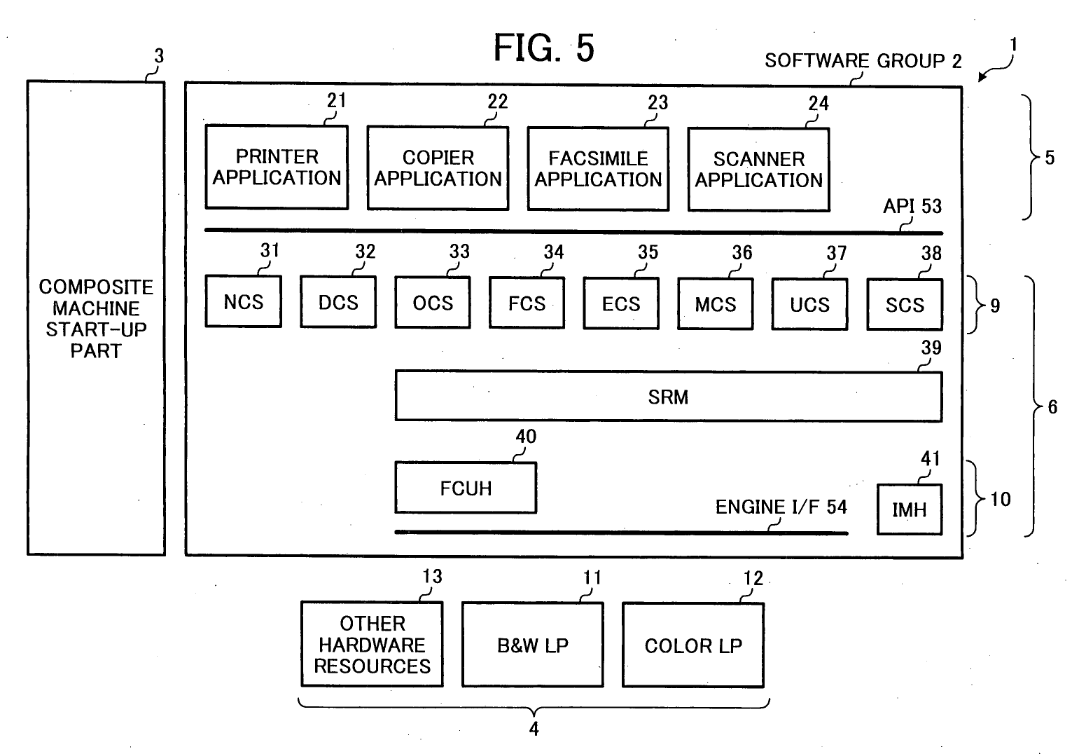

Referring now to FIG. 5, a schematic diagram of an image forming apparatus, hereinafter referred to as a composite machine 1, is described. The composite machine 1 of FIG. 5 includes functions of a printer, a copier, a facsimile machine, a scanner, or the like, in a single housing.

The composite machine 1 of FIG. 5 is configured to include a software group 2, a composite machine star-up part 3, and a hardware resource 4.

When the composite machine 1 is powered up, the composite machine start-up part 3 initially starts up to activate an application layer 5 and a platform 6, details of both of which will be described later. For example, the composite machine start-up part 3 may read programs of the application layer 5 and the platform 6 from the hard disk drive (hereinafter, referred to as a HDD) or the like, corresponding to an external memory unit, and transfers each of the thus read-out programs to respective memory areas to be activated.

The hardware resource 4 includes a black and white laser printer 11 (or B&W LP 11), a color laser printer 12 (Color LP 12), and other hardware resources 13 such as the scanner and the facsimile machine.

Now, the software group 2 includes application layer 5 and platform 6, each of which is operated on an operating system (OS), such as UNIX (registered trademark).

Application layer 5 includes programs for executing processing specific to respective user services associated with the image forming operations performed by the printer, the copier, the facsimile machine, and the scanner, respectively.

More specifically, application layer 5 includes a printer application 21 that is an application program for use in the printer, a copier application 22 that is an application program for use in the copier, a facsimile application 23 that is an application program for use in the facsimile machine, and a scanner application 24 that is an application program for use in the scanner. Each application may be executed when the user service specific to certain hardware resource is executed.

It is noted that the composite machine 1 can perform, in an integrated manner, necessary processing in common for respective application programs, by using platform 6.

Platform 6 includes a control service layer 9, a system resource manager (SRM) 39, and a handler layer 10.

Control service layer 9 interprets a processing request from application layer 5 to generate an acquisition request for hardware resource 4. The SRM 39 controls at least one of the B&W LP 11, the Color LP 12, and the other hardware resources 13 included in the hardware resource 4 so that the acquisition requests sent from the control service layer 9 may be adjusted. The handler layer 10 controls the hardware resource 4 in response to the acquisition request from the SRM 39.

Platform 6 further includes an application program interface (API) 53 capable of receiving the processing request from application layer 5 by-using a predetermined function. The OS is capable of performing a parallel execution, as processes, of respective software programs included in application layer 5 and platform 6.

Control service layer 9 is configured to include at least one service module, such as a network control service module (NCS module) 31, a delivery control service module (DCS module) 32, an operation panel control service module (OCS module) 33, a facsimile control service module (FCS module) 34, an engine control service module (ECS module) 35, a memory control service module (MCS module) 36, a user information control service module (UCS module) 37, a system control service module (SCS module) 38, or the like.

A process of the NCS module 31 provides services used in common by the application programs which require a network input and output. More specifically, the process of the NCS module 31 performs as an intermediary for distributing data received from the network via each protocol to each application program and for transmitting data from each application program to the network. For example, the NCS module 31 controls data communications by using network devices connected through the network using a HyperText Transfer Protocol (HTTP) with the help of a HyperText Transfer Protocol Daemon (HTTPD).

A process for the DCS module 32 controls distribution of stored documents, or the like. A process for the CCS module 33 controls an operation panel which serves for transmitting information between the operator and the main body control. The PCS module 34 provides the API 53 for performing the facsimile transmission such as sending and receiving of the facsimile data using a public switched telephone network (PSTN) or an integrated service digital network (ISDN) from application layer 5, registration and citation of various facsimile data managed by using a backup memory, and reading and printing of received facsimile data.

A process of the ESC module 35 controls an engine control part such as the B&W LP 11, the Color LP 12, the other hardware resources 13, or the like. A process of the MCS module 36 executes memory control such as acquisition and release of a memory, use of the HDD, or the like. A process of the UCS module 37 manages user information. A process of the SCS module 38 executes processing such as application management, control of the operation part, system screen display, light emitting diode (LED) display, hardware resource management, interrupt application protocol, or the like. A process for the SRM 39 performs, along with the SCS module 38, system control and management of hardware resource 4. For example, the process of the SRM 39 performs an intermediary based on the acquisition requests from upper layers using the hardware resource 4 such as the B&W LP 11 or the Color LP 12 to perform the control.

More specifically, the process of the SRM 39 determines whether or not the requested hardware resource 4 is available, or whether or not the resource is already being used by another acquisition request. When the requested hardware resource 4 is available, the SRM 39 notifies the upper layers that the requested hardware resource 4 is available. Furthermore, when the requests are received from the upper layers, the process of the SRM 39 performs scheduling for using the hardware resource 4, and directly executes requested contents, such as paper feeding and image forming operation, memory acquisition, file generation, or the like by a printer engine.

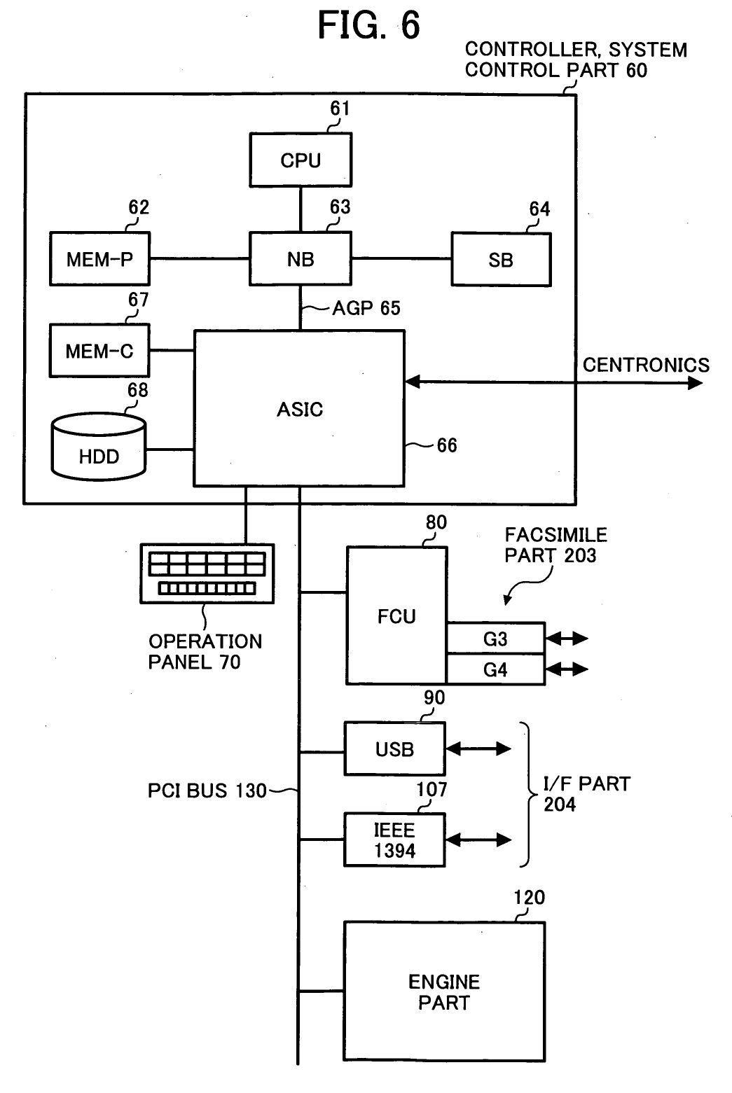

The handler layer 10 includes a facsimile control unit handler (FCUH) 40, an image memory handler (IMH) 41, and an engine interface 54. The FCUH 40 is used for controlling a facsimile control unit (FCU) 80, which will be described below while referring to FIG. 6. The IMH 41 is used for allocating the memory for respective processes and controlling the memory allocated to the processes. Based on a predetermined function, the engine interface 54 transmits the processing requests for the hardware resource 4. The SRM 39 and the FCHU 40 execute processing requests for the hardware resource 4, by using the engine interface 54.

Referring now to FIG. 6, a hardware structure of the composite machine 1 is described. The composite machine 1 can allow platform 6 to monogenerically perform necessary processes in common to each application.

The composite machine 1 of FIG. 6 includes a controller 60, an operation panel 70, the FCU 80, a universal serial bus (USB) device 90, an IEEE1394 device 107, and an engine part 120. The G3 and the G4 described above indicate the data transfer protocol on which the transmitted image data is processed.

The controller 60 includes a central processing unit (CPU) 61, a system memory 62 (or a MEM-P 62), a north bridge (NB) 63, a south bridge (SB) 64, an application, specific integrated circuit (ASIC) 66, a local memory 67 (or a MEM-C 67), and a hard disk drive (HDD) 68. The operation panel 70 is connected with the ASIC 66 of the controller 60. Moreover, the FCU 80, the USB device 90, the IEEE1394 device 107, and the engine part 120 are connected with the ASIC 66 of the controller 60 via a peripheral component interconnect (PCI) bus 130. In addition, the controller 60 is connected externally via a centronics.

In the controller 60, the ASIC 66 is connected with the local memory (MEMTC) 67 and the HDD 68. The ASIC 66 is also connected with the CPU 61 via the NS 63 of a CPU chip set. Thus, by connecting the CPU 61 and the ASIC 66 via the NB 63, the controller 60 can deal with a case in which an interface of the CPU 61 is not opened to the public. It is important to note that the ASIC 66 and the NB 63 are not connected via the PCI bus 130, but are connected via an Accelerated Graphic Port (AGP) 65. Thus, by connecting the ASIC 66 and the NB 63, not via the PCI bus having a low speed but via the AGP 65, to control the execution of one or more processes that form application layer 5 or the platform 6 in FIG. 5, degradation in performance can be avoided.

The CPU 61 performs control of the entire composite machine 1. The CPU 61 starts up the NCS module 31, the DCS module 32, the OCS module 33, the FCS module 34, the ECS module 35, the MCS module 36, the UCS module 37, the SCS module 38, the SRM 39, the FCUH 40, and the IMH 41, as processes, to execute on the OS, respectively. The CPU 61 also starts up the printer application 21, the copy application 22, the facsimile application 23, and the scanner application 24, which form the application layer 5, to execute.

The NB 63 is a bridge for connecting the CPU 61, the MEM-P 62, the SB 64, and the ASIC 66. The MEM-P 62 is a memory used by the composite machine 1 for drawing images, or the like. The SB 64 is a bridge for connecting between the NB 63 and a read-only memory (ROM), the local memory 67, and peripheral devices. The local memory 67 is a memory for the purpose of a code buffer and an image buffer used for copying.

The ASIC 66 is an integrated circuit (IC) configured to include hardware elements for the purpose of processing images. The HDD 68 is a storage configured to store the image data, document data, the programs, and font data along with data having various forms, or the like. The operation panel 70 is an operation part for receiving input operations by the operator, and also for providing displaying for the operator.

The FCU device 80 sends and receives the image data to and from the facsimile part 203 via the G3 and G4 PAX protocol. The USB device 90 and the IEEE1394 device 107 communicate with the interface part 204 that controls the input and output to and from the external devices.

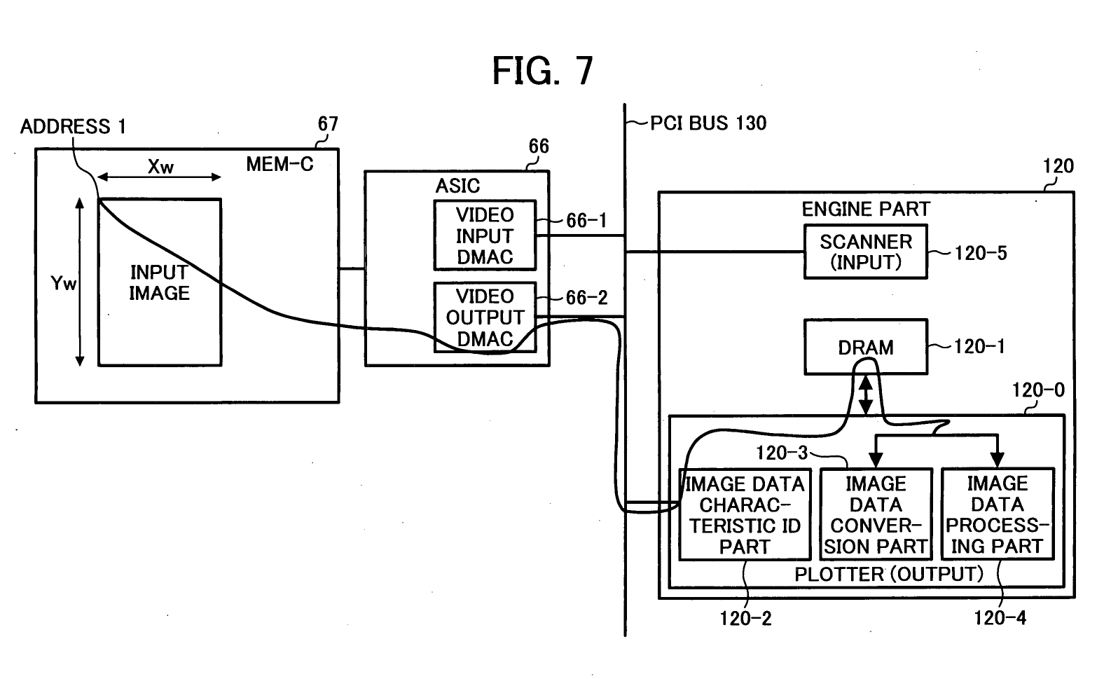

Referring now to FIG. 7, a schematic configuration of a main portion of the composite machine 1 is described.

In FIG. 7, the main portion includes the engine part 120 connected with the ASIC 66 and the local memory (MEM-C) 67 via the PCI bus 130.

The engine part 120 includes a plotter 120-0, a dynamic random access memory (DRAM) 120-1, and a scanner (input) 120-5.

The DRAM 120-1 stores all of or a part of the images input from the scanner (input) 120-5, converts the image data stored in the scanner (input) 120-5 so as to transfer to the local memory (MEM-C) 67. A curved heavy line having an arrow indicates a flow of the image data. The scanner (input) 120-5 performs image conversion and transfers the converted image. The plotter 120-0 performs image recognition, image conversion, image processing, and the like.

The ASIC 66 includes a functioning of a direct memory access controller (DMA controller) for transferring the images. The ASIC 66 is also provided with a video input DMAC 66-1 and a video output DMAC 66-2.

When transferring the image data read by the reading part 100 to the local memory (MEM-C) 67, the IMH 41 reserves a memory space equivalent to a size of the transferred image in the local memory (MEM-C) 67 in response to a processing request from the SRM 39 to set the size of the transferred image with “Xw times Yw” and a reserved memory address to the video input DMAC 66-1, so that the image data can be transferred. In the engine part 120, the transferred image data may have image data identification processing performed by an image data characteristic identification part 120-2, be stored in the DRAM 120-1 of the engine part 120, and have image data conversion processing by an image data conversion part 120-3 or have image data processing by an image data processing part 120-4.

The image data identification part 120-2 of this embodiment performs the image data characteristic identification to identify a characteristic of an image signal of image data. Upon setting an image data identification start signal, the image data identification part 120-2 starts identifying the characteristic of the image signal. When a completion of an image data characteristic identification for one page is detected, a process of the image data characteristic identification is completed. When a characteristic of the image data signal is identified at any point between the start and the end of the image data characteristic identification, that is, when a result of the image data characteristic identification is obtained during the process of the image data characteristic identification, the image data characteristic identification is completed and it is determined that the characteristic of the image data signal of the image data is identified. When the result of the image data characteristic identification is not obtained during the process of the image data characteristic identification, the image data characteristic identification is completed and it is determined that the characteristic of the image data signal of the image data is not identified. When a completion of the image data characteristic identification for one page is detected, the process of the image data characteristic identification is completed.

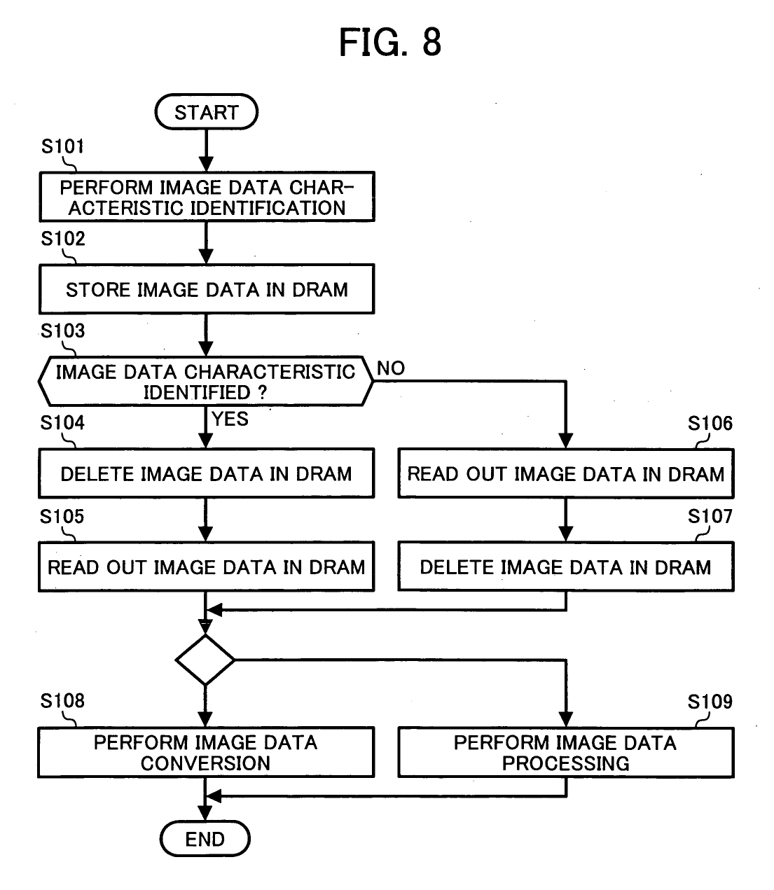

Referring to FIGS. 8 to 11, flowcharts showing respective processing procedures in composite machine 1 will be described. In the flowcharts of FIGS. 8 through 11, the CPU 61 of the controller 60 generally gives instructions to the ASIC 66 of the controller 60 so that the ASIC 66 may perform the following processing procedures.

FIG. 8 is a flowchart showing a processing procedure performed by the ASIC 66 of the controller 60 in the composite machine 1 for changing an order of deleting and reading out the image data stored in the memory unit, according to a characteristic of the image data.

The ASIC 66 of the controller 60 has a function capable of selecting an order of deleting the image data stored in the DRAM (corresponding to an internal memory unit) 1201 in the engine part (corresponding to an image output unit) 120. That is, when it is found the image signal of the image data has a predetermined characteristic, the controller 61 can select whether the image data stored in the DRAM 120-1 is deleted before or after the read out of the image data.

In step S101 of FIG. 8, the ASIC 66 performs a characteristic identification of an image data signal of image data transferred from the local memory (MEM-C) 67 to obtain a result of the image data characteristic identification. After step S101, the process goes to step S102.

In step S102, the ASIC 66 stores the image data transferred from the local memory (MEM-C) 67 in the DRAM 120-1.

In step S103, it is determined whether the ASIC 66 identifies a characteristic of the image data signal of the image data transferred from the local memory (MEM-C) 67.

When the ASIC 66 identifies the characteristic of the image data signal, the determination result in step S103 is YES, and the ASIC 66 deletes the image data having the characteristic stored in the DRAM 120-1 in step S 104, and reads out the image data stored in the DRAM 120-1 in step S105. After step S105, the process goes to one of steps S108 and S109. Since the image data read out from the DRAM 120-1 in step S105 is already deleted, the image data processed in the following steps is blank data indicating that the read data is deleted.

When the ASIC 66 does not identify the characteristic of the image data signal, the determination result in step S103 is NO, the ASIC 66 reads out the image data stored in the DRAM 120-1 in step S106, and deletes the image data in step S107 after the completion of reading out the image data. After step S107, the process goes to one of steps S108 and S 109. Accordingly, the image data processed in the following steps is the data stored in the DRAM 1201 in step S102.

Upon completion of deleting the image data in the DRAM 120-1 and reading out the image data from the DRAM 120-1 (performed in steps S104 and S105 or steps S106 and S107), the ASIC 66 performs image data conversion by the image data conversion part 120-3 in step S108 or image data processing by the image data processing part 120-4 in step S109. After step S108 or step S109, the ASIC 66 completes the procedure.

Thus, the ASIC 66 performs the processing procedure for changing the order of deleting and reading out the image data stored in the DRAM 120-1, according to the result of the characteristic identification of the image data.

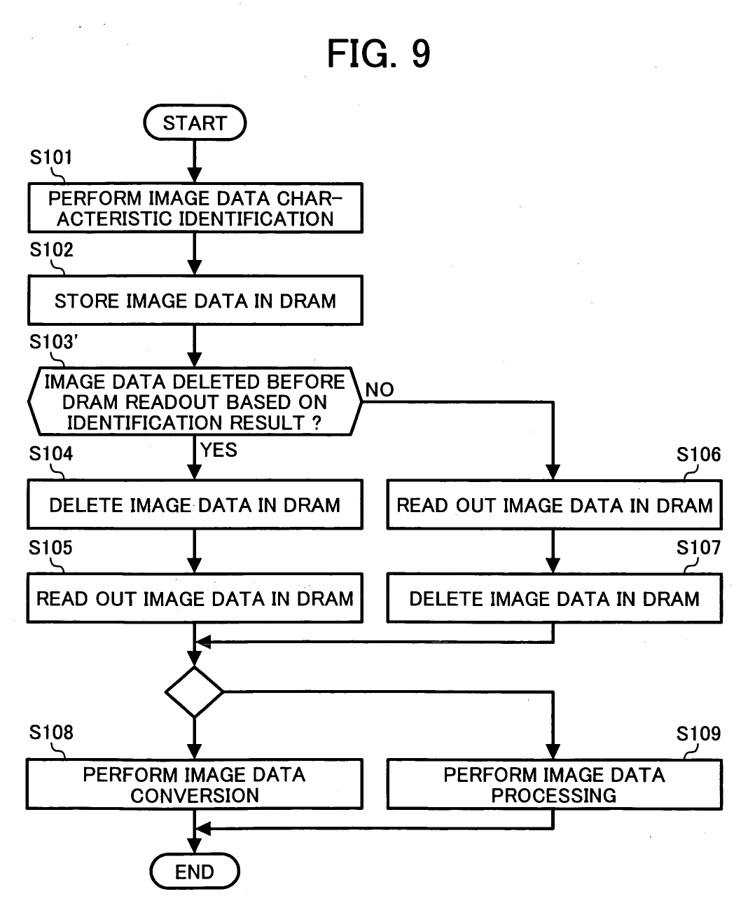

FIG. 9 is a flowchart showing a processing procedure performed by the ASIC 66 in the composite machine 1 for changing an order of deleting and reading out the image data stored in the memory unit, according to an input signal from an external device.

According to the characteristic of an image data signal input from an external device to an image input unit, the controller 61 can select whether the image data stored in a memory of the image input unit is deleted before or after the read out from the image data.

In step S101 of FIG. 9, the ASIC 66 receives image data from the external device to store in the local memory (MEM-C) 67, and then performs a characteristic identification of an image data signal of image data transferred from the local memory (MEM-C) 67 to obtain a result of image data characteristic identification. After step S101, the process goes to step S102.

In step S102, the ASIC 66 stores the image data transferred from the external device via the local memory (MEM-C) 67 in the DRAM 120-1.

In step S103′, it is determined, based on the result of image data characteristic identification, whether the image data signal of the image data has a characteristic to be deleted before reading out the DRAM 120-1. That is, it is determined whether a characteristic of the image data signal of the image data to be deleted before reading out the DRAM 120-1 is identified.

When the image data has the characteristic to be deleted, the determination result in step S103′ is YES, and the ASIC 66 deletes the image data having the characteristic transmitted from the external device and stored in the DRAM 120-1 in step S104, and reads out the image data stored in the DRAM 120-1 in step S105. After step S105, the process goes to one of steps S108 and S109. Since the image data read out from the DRAM 120-1 in step S105 is already deletes, the image data processed in the following steps is blank data indicating that the read data is deleted.

When the image data does not have the characteristic to be deleted, the determination result in step S103′ is NO, and the ASIC 66 reads out the image data stored in the DRAM 120-1 in step S106, and deletes the image data in step S107 after the completion of reading out the image data. After step S107, the process goes to one of steps S108 and S109. Accordingly, the image data processed in the following steps is the data stored in the DRAM 120-1 in step S102.

Upon completion of deleting the image data in the DRAM 120-1 and reading out the image data from the DRAM 120-1 (performed in steps S104 and S105 or steps S106 and S107), the ASIC 66 performs the image conversion by the image data conversion part 120-3 in step S108 or the image processing by the image data processing part 120-4 in step S109. After step S108 or step S109, the ASIC 66 completes the procedure.

Thus, the ASIC 66 performs the processing procedure for changing the order of deleting and reading out the image data stored in the DRAM 120-1, according to the characteristic of the image input signal from the external device.

The processing procedures of the respective flowcharts of FIGS. 8 and 9 are similar to each other, except that the flowchart of FIG. 8 is for the processing procedure focusing on a characteristic of the image data signal of the image data stored in the DRAM 120-1 while the flowchart of FIG. 9 is for the processing procedure with the determination whether the image data signal of the image data input from the external device includes a characteristic which may cause the image data stored in the DRAM 120-1 to be deleted.

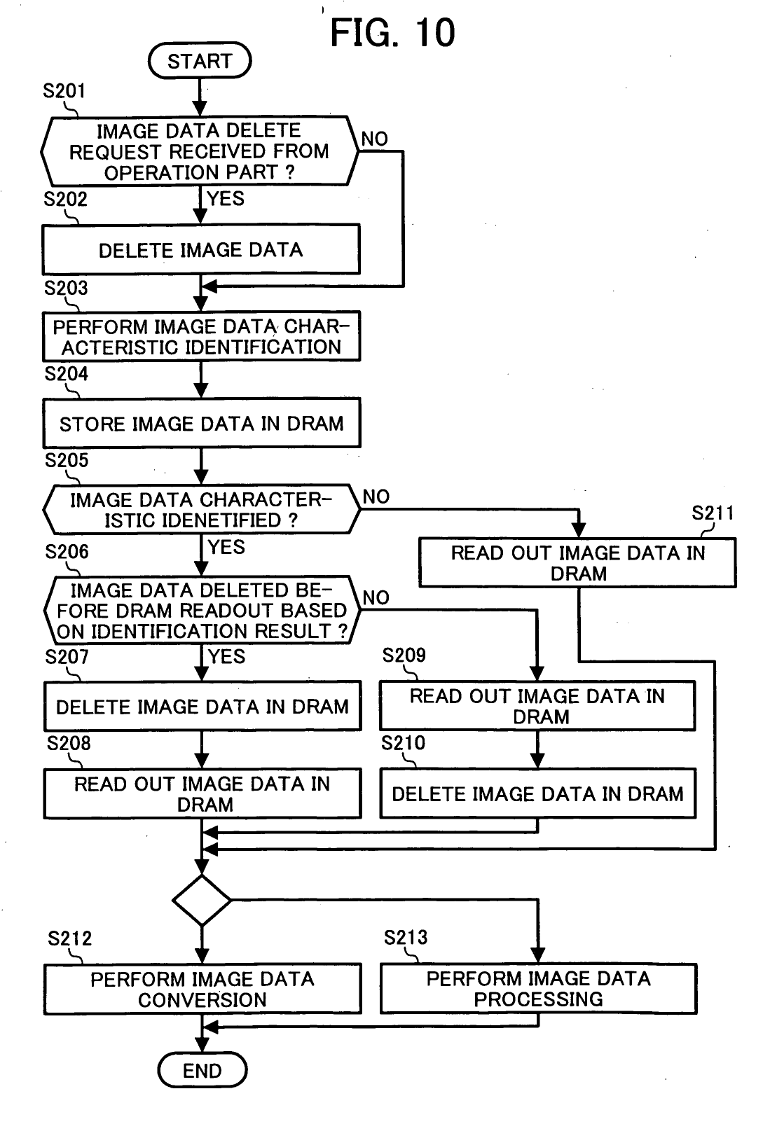

FIG. 10 is a flowchart showing a processing procedure performed by the ASIC 66 of the controller 60 in the composite machine 1 for deleting the image data regardless of switching instructions from the external device when a characteristic of an image data signal of image data is identified.

The following example of the processing procedure shows a case in which the image data characteristic identification part 120-2 of the plotter control part 314 identifies image data including a characteristic of marketable securities or paper currency, which are prohibited to be copied.

When the image data characteristic identification part 120-2 identifies that the image data includes the characteristic of the marketable securities or paper currency, the image data is deleted regardless of switching instructions sent from the external device.

In step S201 of FIG. 10, it is determined whether the controller 60 receives an image data delete request sent from the operation part 202.

When the ASIC 66 of the controller 60 does not receive the image data delete request from the operation part 202, the determination result in step S201 is NO, the process goes to step S203.

When the ASIC 66 receives the image data delete request from the operation part 202, the determination result in step S201 is YES, the ASIC 66 deletes the image data transferred from the local memory (MEM-C) 67 in step S202, and the process goes to step S203.

In step S203, the ASIC 66 performs a characteristic identification of an image data signal of image data transferred from the local memory (MEM-C) 67 to obtain a result of image data characteristic identification. After step S203, the process goes to step S204.

In step S204, the ASIC 66 stores the image data transferred from the local memory (MEM-C) 67 in the DRAM 120-1. After step S204, the process goes to step S205.

In step S205, it is determined whether the characteristic of the image data signal of the image data transferred from the local memory (MEM-C) 67 is identified.

When the characteristic of the image data signal is identified, the determination result in step S205 is YES, it is determined, based on the result of the image data characteristic identification, whether the characteristic to be deleted before reading out the image data from the DRAM 120-1 is identified in step S206.

When the characteristic to be deleted before reading out the image data from the DRAM 120-1 is identified, the determination result in step S206 is YES, the image data stored in the DRAM 120-1 in step S204 is deleted in step S207, and the image data stored in the DRAM 120-1 is read out in step S208. After step S208, the process goes to one of steps S212 and S213.

When the characteristic to be deleted after reading out the image data from the DRAM 120-1 is not identified, the determination result in step S206 is NO, the image data stored in the DRAM 120-1 in step S204 is read out in step S209, then the image data read out from the DRAM 120-1 is deleted in step S210. After step S210, the process goes to one of steps S212 and S213.

When the characteristic of the image data signal is not identified, the determination result in step S205 is NO, the ASIC 66 reads out the image data stored in the DRAM 120-1 in step S211. After step S211, the process goes to one of steps S212 and S213.

Upon completion of deleting the image data in the DRAM 120-1 and reading out the image data from the DRAM 120-1 (performed in steps S207 and S208 or steps S209 and S210) or upon completion of reading out the image data form the DRAM 120-1 (performed in step S211), the ASIC 66 performs the image data conversion by the image data conversion part 120-3 in step S212 or the image data processing by the image data processing part 120-4 in step S213. After step S212 or step S213, the ASIC 66 completes the procedure.

By performing the above-described procedure, the ASIC 66 deletes the image data when the image data includes the characteristic of the marketable securities or paper currency, regardless of a key entry from the operation part 202, thereby preventing output of the image data not permitted to be copied and allowing deletion of the image data not permitted to be copied stored in the image forming apparatus.

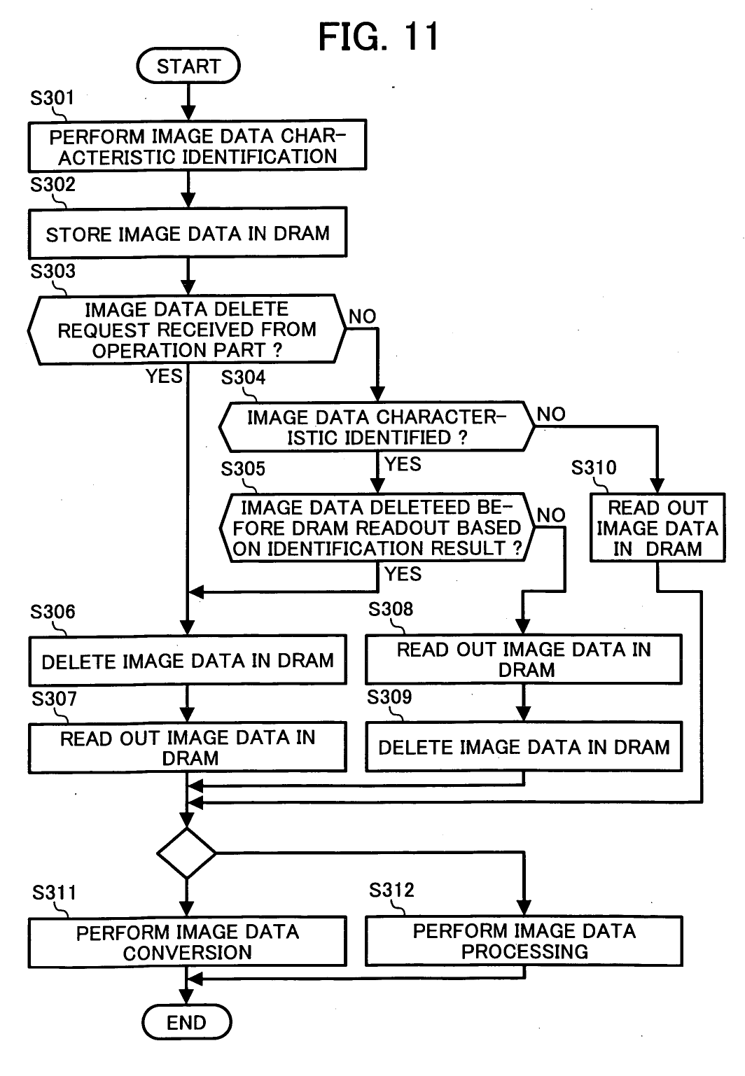

FIG. 11 is a flowchart showing a processing procedure performed by the ASIC 66 of the controller 60 in the composite machine 1 for forcibly deleting the image data stored in the memory when a predetermined characteristic of an image data signal of image data is identified. The image data may be deleted before reading out the image data from the memory of the image input unit. The predetermined characteristic may be, for example, related to paper currency or marketable securities.

In step S301 of FIG. 11, the ASIC 66 performs a characteristic identification of an image data signal of image data transferred from the local memory (MEM-C) 67 to obtain a result of image data characteristic identification. After step S301, the process goes to step S302.

In step S302, the ASIC 66 stares the image data transferred from the local memory (MEM-C) 67 in the DRAM 120-1.

In step S303, it is determined whether the controller 60 receives an image data delete request sent from the operation part 202.

When the ASIC 66 of the controller 60 receives the image data delete request from the operation part 202, the determination result in step S303 is YES, the process goes to step S306.

The image data stored in the DRAM 120-1 in step S302 is deleted in step S306, and the image data stored in the DRAM 120-1 is read out in step S307. After step S307, the process goes to one of steps S311 and S312. Since the image data read out from the DRAM 120-1 in step S307 is already deleted, the image data processed in the following steps is blank data indicating that the read data is deleted.

When the ASIC 66 of the controller 60 does not receive the image data delete request from the operation part 202, the determination result in step S303 is No, it is determined whether the characteristic of the image data signal of the image data is identified in step S304.

When the characteristic of the image data signal is identified, the determination result in step S304 is YES, and it is determined, based on the result of the image data characteristic identification, whether the characteristic to be deleted before reading out the image data from the DRAM 120-1 is identified in step S305.

When the characteristic to be deleted before reading out the image data from the DRAM 120-1 is identified, the determination result in step S305 is YES, and the image data stored in the DRAM 120-1 in step S302 is deleted in step S306, and the image data (or the blank data) stored in the DRAM 120-1 is read out in step S307. After step S307, the process goes to one of steps S311 and S312.

When the characteristic to be deleted after reading out the image data from the DRAM 120-1 is identified, the determination result in step S305 is NO, and the image data stored in the DRAM 120-1 in step S302 is read out in step S308, then the image data read out from the DRAM 120-1 is deleted in step S309. After step S309, the process goes to one of steps S311 and S312.

When the characteristic of the image data signal is not identified, the determination result in step S304 is NO, and the image data stored in the DRAM 120-1 is read out in step S310. After step S310, the process goes to one of steps S311 and S312.

Upon completion of deleting the image data in the DRAM 120-1 and reading out the image data from the DRAM 120-1 (performed in steps S306 and S307 or steps S308 and S309) or upon completion of reading out the image data form the DRAM 120-1 (performed in step S310), the ASIC 66 performs the image data conversion by the image data conversion part 120-3 in step S311 or the image data processing by the image data processing part 120-4 in step S312. After step S311 or step S312, the ASIC 66 completes the procedure.

By performing the processing procedure as described above, the ASIC 66 deletes the image data before being read out when the image data is not permitted to be copied regardless of a key entry from the operation part 202. Thus, output of the image data not permitted to be copied is prevented, and deletion of the image data not permitted to be copied stored in the image forming apparatus is allowed.

As described above, according to an exemplary embodiment, the image data stored in the DRAM 120-1 (for example, the memory unit) of the engine part 120 (for example, the image output unit) is first read out (output) from the DRAM 120-1 of the engine part 120 (for example, in step S106), and then deleted from the DRAM 120-1 (for example, in step S107). Therefore, it is possible to prevent the image data in an entire digital copier (or an image forming apparatus) from being leaked.

Furthermore, the image data stored in the DRAM 120-1 (fox example, the memory unit) of the engine part 120 (for example, the image output unit) may be deleted before it is read out or outputted (for example, steps S104 and S105). The image data stored in the DRAM 120-1 (for example, the memory unit) may be deleted after it is read out or outputted (for example, steps S106 and S107). Therefore, when the image data is outputted from the engine part 120 (for example, the image output unit) to the external device as needed, unnecessary image data may not be sent to the external device and a leakage of the image data may be prevented.

Furthermore, the engine part 120 (for example, the image input unit) includes the image data characteristic identification part 120-2 which identifies the characteristic of the image data signal of the image data so that an order of deleting the image data (or an image data deletion order) in the DRAM 120-1 (for example, the buffer memory) may be selected based on the result of characteristic identification performed by the image data characteristic identification part 120-2. Therefore, the engine part 120 automatically determines necessity of the image data signal and performs the deletion of the image data. At the same time, the engine part 120 (for example, the image output unit) may not send the unnecessary image data to the external device so that the leakage of the image data may be prevented and a more definitive way of keeping strict secrecy of information may be provided.

Moreover, when the engine part 120 (for example, the image output unit or the plotter) deletes the image data, it is desirable that some application using the engine part 120 (the image output unit or the plotter) may not automatically delete the image data. For example, when the same image data is repeatedly outputted for a plurality of times, the productivity of the image output may be improved by deleting the image data at the completion of the entire job of outputting and not deleting the image data at the completion of each cycle of image output. Therefore, in an exemplary embodiment, an operation unit (for example, the operation panel) is provided to allow the external device (for example, the operation part) to determine whether the image data is deleted from the local memory (MEM-C or the image input unit) 67. With the above-described structure, a versatile control according to operations of the image forming apparatus may be achieved.

Furthermore, when the characteristic of a specific image data signal which is not permitted to be copied (for example marketable securities) is identified, the image data stored in the buffer memory is instantly deleted regardless of instructions given by the external device out of the image output unit. Therefore, the leakage of image data as well as the output (leakage) of the image data prohibited to be copied may be prevented.

Furthermore, an operation or step for deleting image data may be selected to forcidly delete the image data stored in the memory of the image output unit before the image data is read out. Thus, when the image data is output from the image data output unit to the external device, the unnecessary image data may not be outputted to the external device out of the image data output unit and the leakage of the image data may be prevented.

The above-described embodiments are illustrative, and numerous additional modifications and variations are possible in light of the above teachings. For example, elements and/or features of different illustrative and exemplary embodiments herein may be combined with each other and/or substituted for each other within the scope of this disclosure and appended claims. It is therefore to be understood that within the scope of the appended claims, the disclosure of this patent specification may be practiced otherwise than as specifically described herein.

1. An image input and output apparatus, comprising:
an image input unit configured to input an image data signal of image data;
a memory configured to store the image data signal of the image data input from the image input unit;
an image output unit configured to output the image data signal of the image data stored in the memory;
a first internal memory unit disposed in the image output unit and configured to store the image data input from outside of the image output unit;
a first deletion unit configured to delete the image data from the first internal memory unit before reading out the image data therefrom;
a second deletion unit configured to delete the image data from the first internal memory unit after reading out the image data therefrom;
an identification unit configured to identify a characteristic of the image data; and
a selection unit configured to select one of the first and second deletion units to delete the image data stored in the first internal memory unit according to the characteristic of the image data.

2. The image input and output apparatus according to claim 1, wherein:
the selection unit is configured to select the first deletion unit when the identification unit identifies the characteristic of the image data signal of the image data, and
the selection unit is configured to select the second deletion unit when the identification unit identifies no characteristic of the image data signal of the image data.

3. The image input and output apparatus according to claim 2, wherein:
the identification unit is configured to determine whether the characteristic of the image data signal of the image data is identified during a period from a start of the image data characteristic identification to an end of the image data characteristic identification.

4. The image input and output apparatus according to claim 3, wherein:
the identification unit is configured to determine whether the characteristic of the image data signal of the image data read by the image input unit is identified.

5. The image input and output apparatus according to claim 3, wherein:
the identification unit is configured to determine whether the characteristic of the image data signal of the image data stored in the memory is identified.

6. The image input and output apparatus according to claim 1, further comprising:
an operation unit configured to execute a selection performed by the selection unit, wherein the operation unit is located outside of the image output unit.

7. The image input and output apparatus according to claim 1, wherein:
the image data signal of the image data includes a characteristic of a document image prohibited to be copied,
said document image including an image of at least one of a marketable security and paper currency.

8. The image input and output apparatus according to claim 1, wherein:
the image data signal of the image data has a characteristic of a document image prohibited to be copied,
said document image including an image of at least one of a marketable security and paper currency, and
when the characteristic of the document image prohibited to be copied is identified in the image data signal of the image data, the selection unit selects the first deletion unit regardless of the selection executed by the operation unit.

9. The image input and output apparatus according to claim 8, wherein:
the selection is forcibly executed.

10. An image input and output apparatus, comprising:
means for inputting an image data signal of image data;
means for storing the image data signal of the image data input from the means for inputting;
means for outputting the image data signal of the image data stored in the means for storing;
first means for internally storing the image data input from outside of the means for outputting, the first means for internally storing being disposed in the image output unit;
first means for deleting the image data from the first means for internally storing before reading out the image data therefrom;
second means for deleting the image data from the first means for internally storing after reading out the image data therefrom;
means for identifying a characteristic of the image data input from outside of the means for inputting; and
means for selecting one of the first and second means for deleting to delete the image data stored in the first means for internally storing according to the characteristic of the image data input from outside of the means for inputting.

11. The image input and output apparatus according to claim 10, wherein:
the means for selecting selects the first means for deleting when the means for identifying identifies the characteristic of the image data signal of the image data, and
the means for selecting selects the second means for deleting when the means for identifying identifies no characteristic of the image data signal of the image data.

12. The image input and output apparatus according to claim 11, wherein:
the means for identifying determines whether the characteristic of the image data signal of the image data is identified during a period from a start of the image data characteristic identification to an end of the image data characteristic identification.

13. The image input and output apparatus according to claim 12, wherein:
the means for identifying determines whether the characteristic of the image data signal of the image data read by the means for inputting is identified.

14. The image input and output apparatus according to claim 12, wherein:
the means for identifying determines whether the characteristic of the image data signal of the image data stored in the means for storing is identified.

15. The image input and output apparatus according to claim 10, further comprising:
means for executing a selection performed by the means for selecting, wherein the means for executing is located outside of the means for outputting.

16. The image input and output apparatus according to claim 10, wherein:
the image data signal of the image data has a characteristic of a document image prohibited to be copied,
said document image including at least one of a marketable security and paper currency.

17. The image input and output apparatus according to claim 10, wherein:
the image data signal of the image data has a characteristic of a document image prohibited to be copied,
said document image including at least one of a marketable security and paper currency, and
when the characteristic of the document image prohibited to be copied is identified in the image data signal of the image data, the means for selecting selects the first means for deleting regardless of the selection executed by the means for executing.

18. The image input and output apparatus according to claim 17, wherein:
the selection is forcibly executed.

19. A method of inputting and outputting image data, comprising:
identifying a characteristic of an image data signal of image data input to an image forming apparatus;
storing the input image data including the characteristic of the image data signal to an internal memory unit;
selecting one of first and second procedures according to the characteristic of the image data signal of the image data identified in the identifying, the first procedure including,
deleting the input image data stored in the storing, and then
reading out the input image data; and
the second procedure including,
reading out the input image data stored in the storing, and then
deleting the input image data.

20. The method according to claim 19, wherein:
the image data signal of the image data is input by an image input unit.

21. The method according to claim 19, wherein:
the image data signal of the image data is input by an image input unit and is stored in a memory.

22. The method according to claim 19, wherein:
the selecting selects the first procedure when an external operation unit sends a request to delete the image data.

23. A computer program product stored on a computer readable storage medium for carrying out an image inputting and outputting method, when running on an image input and output apparatus, the image inputting and outputting method comprising:
identifying a characteristic of an image data signal of image data input to an image forming apparatus;
storing the input image data including the characteristic of the image data signal to an internal memory unit;
selecting one of first and second procedures according to the characteristic of the image data signal of the image data identified in the identifying, the first procedure including,
deleting the input image data stored in the storing, and then
reading out the input image data; and
the second procedure including
reading out the input image data stored in the storing, and then
deleting the input image data.

24. The computer program product according to claim 23, wherein:
the image data signal of the image data is input by an image input unit.

25. The computer program product according to claim 23, wherein:
the image data signal of the image data is input by an image input unit and is stored in a memory.

26. The computer program product according to claim 23, wherein:
the selecting selects the first procedure when an external operation unit sends a request to delete the image data.

27. A computer readable recording medium configured to store computer instructions for performing an image inputting and outputting method, the method comprising:
identifying a characteristic of an image data signal of image data input to an image forming apparatus;
storing the input image data including the characteristic of the image data signal to an internal memory unit;
selecting one of first and second procedures according to the characteristic of the image data signal of the image data identified in the identifying, the first procedure including,
deleting the input image data stored in the storing, and then
reading out the input image data; and
the second procedure including,
reading out the input image data stored in the storing, and then
deleting the input image data.

28. The computer readable recording medium according to claim 27, wherein:
the image data signal of the image data is input by an image input unit.

29. The computer readable recording medium according to claim 27, wherein:
the image data signal of the image data is input by an image input unit and is stored in a memory.

30. The computer readable recording medium according to claim 27, wherein:
the selecting selects the first procedure when an external operation unit sends a request to delete the image data.
